(19) United States
(12) Patent Application Publication
(10) Pub. No.: US 2021/0277641 A1
(43) Pub. Date: Sep. 9, 2021

(54) DIRECTIONAL DRAIN WAND AND METHOD OF DRAIN CLEANING USING THE SAME

(71) Applicant: Michael F. Houtkin, Boca Raton, FL (US)

(72) Inventor: Michael F. Houtkin, Boca Raton, FL (US)

(21) Appl. No.: 17/173,553

(22) Filed: Feb. 11, 2021

Related U.S. Application Data
(60) Provisional application No. 62/975,302, filed on Feb. 12, 2020.

(51) Int. Cl. E03C 1/306; B08B 9/032

(52) U.S. Cl. CPC E03C 1/306; B08B 2209/032; B08B 9/0321

(57) ABSTRACT

A directional drain wand comprises a handle having i) a manually actuated valve assembly, ii) an inlet water coupling on an inlet side of the valve assembly configured to be coupled to a conventional building water line, and iii) a water outlet on an outlet side of the valve assembly; A wand body coupled to the water outlet; and a plurality of wand tips, each wand tip configured to be selectively coupled to the wand body and each wand tip having at least one opening defining a directional spray from the wand body, wherein different wand tips provide different directional sprays, and wherein the wand body and wand tips are configured to fit through openings of a drain cover. A method of cleaning a drain with a drain cover comprises use of the directional drain wand with a desired wand tip.

### RELATED APPLICATIONS

This application claims the benefit of U.S. Provisional Patent Application Ser. No. 62/975,302 filed Feb. 12, 2020 titled “High Pressure User Selected Directional Drain Wand” which is incorporated herein by reference.

### BACKGROUND OF THE INVENTION

### 1. Field of the Invention

This invention generally relates to drain wands for cleaning drains without removing drain covers and methods of using the same.

### 2. Background Information

In a conventional commercial kitchen, such as a restaurant, there are floor drains and other drains covered with drain covers 10 (also called drain strainers and drain grates) which require occasional servicing or cleaning. Floor drains are ubiquitous and are certainly not limited to restaurants or commercial kitchens. However, restaurants floor drains will often experience a quick buildup of fats and grease from residual food, and this can provide a breeding ground for fruit flies and the like. Thus restaurant floor drains will require cleaning on a more regular basis. This is opposed to a floor drain in a residential basement that might not exhibit a similar buildup over a large number of years that an active commercial kitchen floor drain experiences in a few months.

FIGS. 1A, B and C illustrate representative floor drain covers 10. Floor drain covers 10 are also found in square shapes and the openings 12 may be a wide variety of shapes as represented. The phrases “drain covers” 10, “drain strainers” and “drain grates” are used interchangeably herein.

Historically, floor drains were cleaned by removing the screws 14 (a representative example of which is shown in FIG. 1C) that hold the drain cover 10 in place through fastener openings 16 (representative examples of which is shown in FIGS. 1A and 1B), and then utilizing a pressure washer, which can have water pressures of 1,500-10,000 PSI, to clean the exposed drain pipes of the floor drain. This is a time consuming process. Additionally, the screws 14 have a tendency to break or become stripped over time, thus preventing easy access to the drain. Moreover, the utilization of very high pressure water has two serious drawbacks. First, when high pressure water is sprayed into the drain, much of the offending material is splashed back out, into the surrounding area. When this occurs, the user must expend additional time and effort to clean the mess caused by the drain cleaning itself. Additionally, pressure washers have a typical output that is between 1,000 psi and 5,000 psi. When utilized on the plastic/PVC drains, this high pressure spray may crack the brittle drain members. If such a drain crack occurs, it then becomes necessary to repair the drain, often necessitating the hiring of a plumber or other such professional, thereby resulting in a large repair bill.

Lisa and William Wilson addressed these prior art deficiencies and developed what is known as a “drain wand.” A drain wand is a new class of cleaning tool especially adapted for floor drains without removing the drain cover 10. The specifics of this invention are described in U.S. Pat. No. 9,592,521 titled “Drain Wand”, which patent is incorporated herein by reference. The applicants are using the phrase “drain wand” herein to define a class or category of cleaning tools that can achieve the objectives outlined in the '521 patent, namely a tool adapted for cleaning the floor drain without removal of the drain cover 10. The phrase drain wand is broader than the specific example of a drain wand disclosed in the '521 patent. More precisely, the definition of a drain wand, within the meaning of the present application, is a spraying device that is i) configured to fit within a drain through a drain cover 10 without removing the drain cover, ii) operates at flow rates suitable to clean a drain, and iii) can couple to a conventional house/building water line. A hand actuated valve would also be considered standard for conventional drain wands, although strictly not part of the definition, as one could design a drain wand without its own valve that utilizes the valve on the house/building water line for turning the water on and off, yet this drain wand version would be far less useful in practice (making efficient cleaning a two person job).

The specific drain wand developed by the Wilsons and set forth in the specifics of the '521 patent consisted of a single elongated rigid wand body having a distal end, a proximal end, an internal channel and a uniform shape along an entirety thereof, wherein the wand body includes a length of between 12 and 36 inches, and is constructed from a single steel rod having a uniform outside diameter of ¼ inches; an inlet unit disposed along the proximal end of the wand body, with the inlet unit being in communication with a first end of the internal channel, and including a connector that is configured to be removably connected to a water source; a single sprayer that is positioned transversely within the single elongated rigid wand body at a location between the distal end and the proximal end, said sprayer being in communication with a second end of the internal channel and functioning to discharge water received by the inlet unit in a lateral and non-circular pattern from only one side of the single wand body; and a control unit that is affixed to the inlet unit and is in communication with the internal channel, said control unit including a handle having a trigger that is connected to an internal valve for regulating a flow of the water received by the water source.

The specific drain wand developed by the Wilsons and set forth in the specifics of the '521 patent has a number of drawbacks including limited flow rate and cleaning spray and the need to significantly manually manipulate the drain wand for cleaning some drains. The drain wand of the '541 patent was unable to efficiently clean some drains due to these limitations and has limited the wide adoption of this tool.

There is a need to maintain the advantages of the drain wand developed by the Wilsons and to minimize the shortcomings thereof to facilitate wide adoption of the drain wand cleaning method for drains.

### SUMMARY OF THE INVENTION

The various embodiments and examples of the present invention as presented herein are understood to be illustrative of the present invention and not restrictive thereof and are non-limiting with respect to the scope of the invention. The present invention provides a user selected directional drain wand comprising a spraying pressure cleaning device that is i) configured to fit within a drain through a drain cover without removing the drain cover, ii) operates at pressures and sprays suitable to clean a drain, iii) can couple to a conventional house/building water line, and iv) includes a hand actuated piston grip valve, and wherein the drain wand includes an elongated rigid two piece wand with a first wand body and a plurality of replaceable wand tips having different directional sprays, with the first wand body coupled to a pistol grip valve and water source coupling.

One aspect of the present invention provides a directional drain wand comprising a handle having i) a manually actuated valve assembly, ii) an inlet water coupling on an inlet side of the valve assembly configured to be coupled to a conventional building water line, and iii) a water outlet on an outlet side of the valve assembly; A wand body coupled to the water outlet; and a plurality of wand tips, each wand tip configured to be selectively coupled to the wand body and each wand tip having at least one opening defining a directional spray from the wand body, wherein different wand tips provide different directional sprays, and wherein the wand body and wand tips are configured to fit through openings of a drain cover.

One aspect of the present invention provides a method of cleaning a drain with a drain cover comprising the steps of: A) Providing a directional drain wand comprising a) A handle having i) a manually actuated valve assembly, ii) an inlet water coupling on an inlet side of the valve assembly configured to be coupled to a conventional building water line, iii) a water outlet on an outlet side of the valve assembly; b) A wand body coupled to the water outlet; and c) A plurality of wand tips, each wand tip configured to be selectively coupled to the wand body and each wand tip having at least one opening defining a directional spray from the wand body, wherein different wand tips provide different directional sprays, and wherein the wand body and wand tips are configured to fit through openings of a drain cover; B) Selecting one of the plurality of wand tips, and coupling the selected wand tip to the wand body; C) Coupling the inlet water coupling of the handle to a building water line and turning the water in the water line on; D) Inserting the wand body and selected wand tip through one opening of a drain cover; and E) Manually actuating the valve assembly whereby water flows through the wand body and selected wand tip and along the directional spray formed by the selected wand tip, and simultaneously rotating the drain wand about 360 degrees.

These and other advantages of the present invention are described below in connection with the attached figures in which like reference numerals represent like elements throughout.

### BRIEF DESCRIPTION OF THE FIGURES

FIGS. 1A, B and C illustrate a variety of commercial floor drain covers;

FIG. 2 is an illustration of the operational position of a user selected directional drain wand on a drain according to the present invention;

FIGS. 3A and 3B are side elevation views of two user selected directional drain wands according to two embodiments of the present invention;

FIG. 4 is a side view of a pistol grip valve assembly of the user selected directional drain wand according to the present invention;

FIGS. 5A and 5B show the replaceable tips of the user selected directional drain wand according to the present invention;′

FIGS. 6A and 6B shows the coupling of the replaceable tips to the wand body of the user selected directional drain wand according to the present invention.

FIGS. 7A and 7B are schematic section views of two distinct replaceable tips of the user selected directional drain wand according to the present invention.

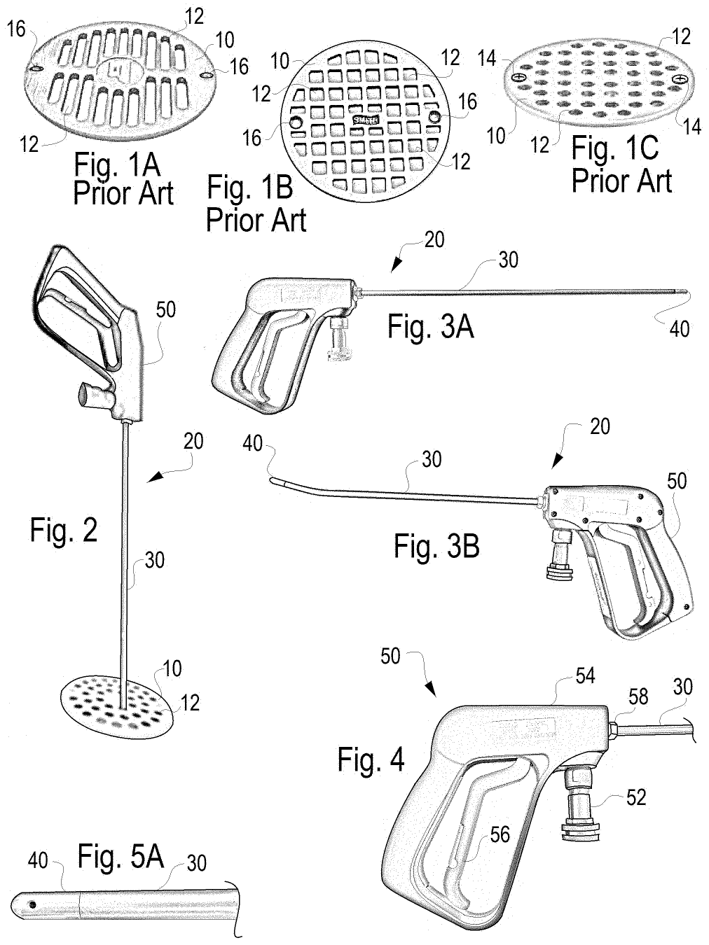

### BRIEF DESCRIPTION OF THE PREFERRED EMBODIMENTS

The user selected directional drain wand 20 according to the present invention is a spraying pressure cleaning device that is i) configured to fit within a drain through openings 12 of a drain cover 10 without removing the drain cover 10, ii) operates at pressures and spray patterns suitable to clean a drain, iii) can couple to a conventional house/building water line, and includes a hand actuated valve. In summary the present invention may be described as a drain wand 20 including an elongated rigid two piece wand with a wand body 30 and a plurality of replaceable wand tips 40 coupled to a pistol grip valve assembly 50. The term “directional” means the cleaning spray of the drain wand 20 is angled or directed by the tip 40 relative to the length of the wand body 30. The particular directions of the spray depend on the selected tip 40 and are discussed below. The phrase “user selected” references that the user can select a desired direction by selecting the desired tip 40, as detailed below.

The operation of the drain wand 20 of the present invention is generally shown in FIG. 2. As illustrated in FIG. 2 the drain wand 20 of the present invention is configured to have the wand body 30 and tips 40 fit within the openings 12 of a drain cover 10 allowing for cleaning of the associated drain without removing the drain cover 10 from the associated drain. The drain wand 20 of the present invention effectively eliminates bug larvae, dirt, grime, grease buildup in drains in minutes of use without removing the drain cover 10.

FIGS. 3A and 3B are side elevation views of two user selected directional drain wands 20 according to two embodiments of the present invention. The only difference between the two embodiments is that the embodiment of FIG. 3B has a bend in the wand body 30 before the wand tip 40 for a different orientation of the wand tips 30.

FIG. 4 highlights the pistol grip valve assembly 50, also called a handle 50. The pistol grip valve assembly 50 includes an inlet water coupling 52 coupled to the housing 54 that houses a valve assembly controlled by a trigger 56 or actuator. The valve assembly will be open when the trigger is pulled back relative to the housing 54 and includes a spring bias to the closed position. The water outlet 58 includes a threaded coupling for the wand body 30. The inlet water coupling 52 uses conventional water attachment, such as found in standard water hose threaded connections.

The particular valve used may also be any of a number of conventional styles actuated by the trigger 56. The 90 degree pistol grip valve assembly 50 orientation of the inlet 52 compared with the outlet 58 is helpful in the drain cleaning application as the hose (not shown) traverses the ground from the source to the drain wands 20 and the pistol grip valve assembly 50, also called a handle 50, re-directs the flow down the wand body 30 which is orientated to better fit down the drain. A pistol grip valve assembly within the meaning of the present invention does not require a precise 90 degree change in flow as in the pistol grip valve assembly 50 shown, but an angle between 80 degrees and 120 degrees are all reasonable for a pistol grip valve assembly within the meaning of the present invention.

The pistol grip valve assembly 50 of the invention would contrast with an inline valve assembly which, if implemented, would require the operator to bend the hose from the water source to access the drain, and this could limit the maneuverability of the drain wand and lead to kinking of the hose that would limit fluid flow. The details of the valve structure of the pistol grip valve assembly 50 of the invention is believed to be known to those of ordinary skill in the art.

As noted above the drain wand 20 comprises an elongated rigid two piece wand with a wand body 30 and a plurality of replaceable wand tips 40. The wand body 30 has a threaded distal end 32 coupled to the replaceable tips 40, a proximal end coupled to the pistol grip valve assembly 50, or handle. The wand body 30 may be any effective length, generally between 8 and 30 inches and is constructed from a single steel rod having a uniform outside diameter of ⅜ inches. The outlet 58 will be of a corresponding size. The wand body 30 and tip 40 diameters are selected to fit the conventional openings 12 of drain covers 10 and to maximize the efficient cleaning provided by the wand 20.

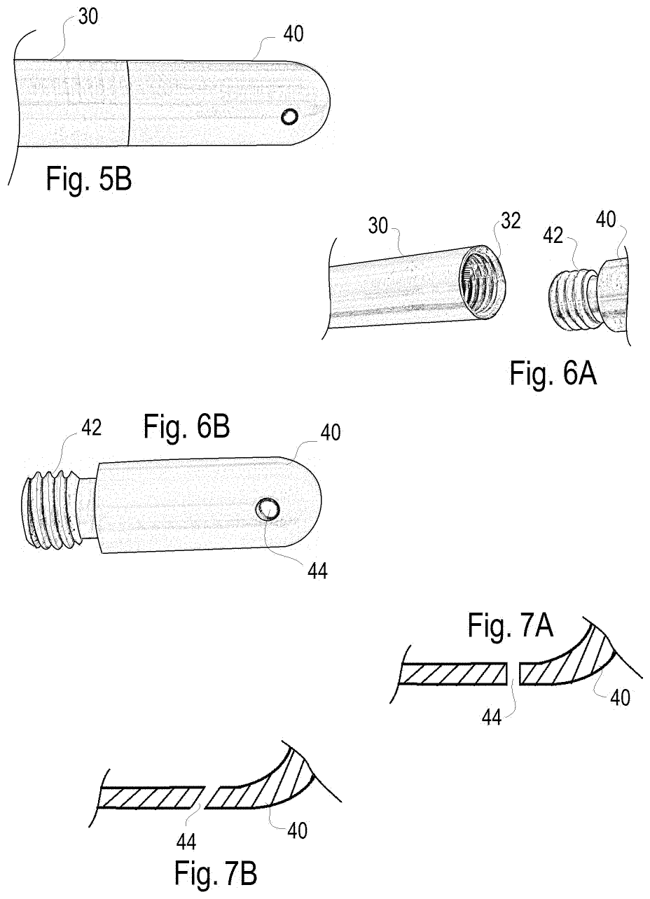

The replaceable directional tips 40 facilitate effective cleaning of the drain. The present device allows the direction of the cleaning spray of the drain wand 20 to be selected by the user and less manual positioning of the wand body 30 is required. FIGS. 5A and 5B show the replaceable tips 40 of the user selected directional drain wand 20 according to the present invention and FIGS. 6A and 6B shows the coupling of the replaceable tips 40 to the wand body 30 of the user selected directional drain wand 20 according to the present invention. The wand body 30 includes a threaded interior 32 receiving matching threads 42 of a selected tip 40. The direction of the spray of water from the tip 44 is defined by the orientation of the opening 44 in the tip 44, wherein FIGS. 7A and 7B are schematic section views of two distinct replaceable tips 40 of the user selected directional drain wand 20 according to the present invention.

The present invention allows the user to select the direction of the cleaning spray based upon one of a plurality of tips 40. Generally two tip directions or orientations of the openings 44 are provided to the user, with the first shown in FIG. 7A and is generally a 90 degree spray (+/−10 degrees). In the “perpendicular tip” of FIG. 7A the cleaning spray out of the opening 44 is perpendicular to the flow through an inlet of the tip 40 and the end of the wand body 30. The second orientation is a back spray tip shown in FIG. 7B wherein the opening 44 results in a spray that is angled in about a sixty-five degree angle essentially back toward the user (+/−10 degrees). The specific directions are not as important as having one tip generally perpendicular and another angled toward the user, these two orientations allows the user to effectively clean all drains.

In general the perpendicular tip 40 of FIG. 7A is preferred for most drains, but some drains have areas more easily cleaned with the back spray tip 40 of FIG. 7B, while some will require the implementation of both tips 40. The threaded coupling 42 of each tip 40 allows the user to easily swap out the tip 40 to a desired directional spray. The openings are schematically shown with parallel sides to better illustrate the orientations, however in practice they may have a conical shape to define a cone or cleaning spray.

The tips 40 may be easily formed of brass with exterior threaded ends 42 matching the threads 32 on the wand body 30. The spray opening 44 is generally a single opening. The interior of the tips 40 are curved to assist in directing the flow through the opening 44, while the curved exterior of the tip 40 assists in placing the wand body 30 and tip 40 through the openings 12 in the drain cover 10.

As noted above the drain wand is configured to operate for efficient drain cleaning. As reference the conventional house or building water supply is 45-80 PSI, and with a conventional water supply the drain wand 20 described above will generally operate at about 125 PSI (+−35 PSI) for conventional water supplies. The above described drain wand 20 design eliminates the need to remove the drain cover 10, whereby drain maintenance is performed by simply inserting the wand body 30 and tip 40 into the drain through the openings 12 in the drain cover 10 and washing away the harborage which is a medium and breeding ground for fruit flies, ants, roaches, and foul smells. With the drain wand in position, and coupled to a source of water, with the source turned on (e.g. the faucet turned on and the source), the user pulls the trigger 56 on the handle, and water disperses at a 90 degree angle to the drain, or an upward angle to the drain (depending upon the tip 40 selected) at approximately 125 psi. The user rotates the drain wand 20 in a 360 degree pattern, thereby cleaning out gelatinous material in the body of the drain.

The method of cleaning a drain with a drain cover according to one aspect of the invention may be described as comprising the steps of:
A) Providing a directional drain wand 20 comprising
   a) A handle 50 having
      i) a manually actuated valve assembly,
      ii) an inlet water 52 coupling on an inlet side of the valve assembly configured to be coupled to a conventional building water line,
      iii) a water outlet 58 on an outlet side of the valve assembly;
   b) A wand body 30 coupled to the water outlet;
   c) A plurality of wand tips 40, each wand tip configured to be selectively coupled to the wand body 30 and each wand tip having at least one opening 44 defining a directional spray from the wand body 30, wherein different wand tips 40 provide different directional sprays, and wherein the wand body 30 and wand tips 40 are configured to fit through openings 12 of a drain cover 10;
B) Selecting one wand tip 40 of the plurality of wand tips 40, and coupling the selected wand tip 40 to the wand body 30;
C) Coupling the inlet water coupling of the handle 50 to a building water line and turning the water in the water line on;
D) Inserting the wand body 30 and selected wand tip 40 through one opening 12 of a drain cover 10;
E) Manually actuating the valve assembly of handle 50 whereby water flows through the wand body 30 and selected wand tip 40 and along the directional spray formed by the selected wand tip 40, and simultaneously rotating the drain wand 10 about 360 degrees.

The drain wand 20 is environmental friendly as it can clean and maintain drains with no chemical applications, and it is easy to use, relatively low cost, extremely time efficient and allows for thorough cleaning of the drain.

The above description is representative of the present invention but not restrictive thereof. The full scope of the present invention are set forth in the appended claims and equivalents thereto.

What is claimed is:

1. A directional drain wand comprises:
a) A handle having
i) a manually actuated valve assembly,
ii) an inlet water coupling on an inlet side of the valve assembly configured to be coupled to a conventional building water line,
iii) a water outlet on an outlet side of the valve assembly;
b) A wand body coupled to the water outlet;
c) A plurality of wand tips, each wand tip configured to be selectively coupled to the wand body and each wand tip having at least one opening defining a directional spray from the wand body, wherein different wand tips provide different directional sprays, and wherein the wand body and wand tips are configured to fit through openings of a drain cover.

2. The directional drain wand according to claim 1, wherein the handle comprises a pistol grip manually actuated valve assembly.

3. The directional drain wand according to claim 2, wherein the directional spray of one wand tip is angled toward the user.

4. The directional drain wand according to claim 2, wherein the directional spray of one wand tip is angled toward the user wherein directional spray is angled in about a sixty-five degree angle relative to a direction of flow through an inlet of the wand tip.

5. The directional drain wand according to claim 4, wherein the inlet of each wand tip is threaded to the wand body.

6. The directional drain wand according to claim 4, wherein the directional spray of one wand tip is angled in about a ninety degree angle relative to a direction of flow through an inlet of the wand tip.

7. The directional drain wand according to claim 6, wherein the drain wand is configured to operate at about 125 PSI.

8. The directional drain wand according to claim 6, wherein the wand body has a uniform outside diameter of ⅜ inches.

9. The directional drain wand according to claim 6, wherein the wand body has a length of between 8 and 30 inches.

10. The directional drain wand according to claim 6, wherein the wand body is a single steel rod and the wand tips are formed of brass.

11. A method of cleaning a drain with a drain cover comprising the steps of:
F) Providing a directional drain wand comprising
a) A handle having
i) a manually actuated valve assembly,
ii) an inlet water coupling on an inlet side of the valve assembly configured to be coupled to a conventional building water line,
iii) a water outlet on an outlet side of the valve assembly;
b) A wand body coupled to the water outlet;
c) A plurality of wand tips, each wand tip configured to be selectively coupled to the wand body and each wand tip having at least one opening defining a directional spray from the wand body, wherein different wand tips provide different directional sprays, and wherein the wand body and wand tips are configured to fit through openings of a drain cover;
G) Selecting one of the plurality of wand tips, and coupling the selected wand tip to the wand body;
H) Coupling the inlet water coupling of the handle to a building water line and turning the water in the water line on;
I) Inserting the wand body and selected wand tip through one opening of a drain cover;
J) Manually actuating the valve assembly whereby water flows through the wand body and selected wand tip and along the directional spray formed by the selected wand tip, and simultaneously rotating the drain wand about 360 degrees.

12. The method of cleaning a drain with a drain cover according to claim 11, wherein the handle comprises a pistol grip manually actuated valve assembly.

13. The method of cleaning a drain with a drain cover according to claim 12, wherein the directional spray of one wand tip is angled toward the user.

14. The method of cleaning a drain with a drain cover according to claim 12, wherein the directional spray of one wand tip is angled toward the user wherein directional spray is angled in about a sixty-five degree angle relative to a direction of flow through an inlet of the wand tip.

15. The method of cleaning a drain with a drain cover according to claim 14, wherein the inlet of each wand tip is threaded to the wand body.

16. The method of cleaning a drain with a drain cover according to claim 14, wherein the directional spray of one wand tip is angled in about a ninety degree angle relative to a direction of flow through an inlet of the wand tip.

17. The method of cleaning a drain with a drain cover according to claim 16, wherein the drain wand is configured to operate at about 125 PSI.

18. The method of cleaning a drain with a drain cover according to claim 16, wherein the wand body has a uniform outside diameter of ⅜ inches.

19. The method of cleaning a drain with a drain cover according to claim 16, wherein the wand body has a length of between 8 and 30 inches.

20. The method of cleaning a drain with a drain cover according to claim 16, wherein the wand body is a single steel rod and the wand tips are formed of brass.
